(19) United States
(12) Patent Application Publication
(10) Pub. No.: US 2007/0260742 A1
(43) Pub. Date: Nov. 8, 2007

(54) Media Storage and distribution in a Local Area Network

(76) Inventor: Evan William Clark, Leichhardt (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 10/581,930

(22) PCT Filed: Oct. 12, 2004
(86) PCT No.: PCT/AU04/01745

§ 371 Date: Mar. 5, 2007

(30) Foreign Application Priority Data
Dec. 10, 2003 (AU) 2003906888

(51) Int. Cl. G06F 17/00

(52) U.S. Cl. 709/231

(57) ABSTRACT

Software for storing and distributing media in a local area network is disclosed. The software comprises library software and player. The library software manages encrypted media files, for example, video files, and sends them to the player on request. The media files may be chapterised and the player may request one or more chapters. The player decodes the encrypted file and displays it. The player improves performance by using predictive chapter buffering, requesting the transfer of the next chapter from the library at time so that the file is completely received and ready to play at the time the current media playing is complete. The player minimizes the number of requests to the library by automatically creating a public folder of received files so that requests for one of the received files in the folder are transferred from the library to the player.

### BACKGROUND OF THE INVENTION

1. Field of the Invention

The invention pertains to the distribution of digital media over a network and more particularly to methods, apparatus and software for storing and distributing media files such as digital video in an environment such as or analogous to a school having classrooms in which there are multiple personal computers.

2. Description of Related Art

There are three basic solutions for the delivery of video on a computer network. The first is streaming of digital video from a server on a local area network of computers to other computers on the network (“local streaming”). The second is streaming of digital video from a server outside a network of computers, over the Internet, to the local area network of computers (“Internet streaming”). The third is storage and access of digital video files from a network drive (“network drive access”).

The streaming of digital video (either local streaming or Internet streaming) occurs when a server pushes video to a client computer in small increments at the same rate as the video is being viewed. No file is transferred in the process. Rather, the server is incrementally telling the client computer what to display in real time. The streaming of digital video has shortcomings. Streaming places a very high workload on the server computer, which limits the number of clients that the video can be sent to. Further, the number of clients that receive the pushed video is limited by the capacity of the network cable, as the video is pushed to each client at the same time. The result when it is pushed to too many terminals is that the video slows down or stops. Further, the video must be delivered from a central server, as other computers on the network are not capable of streaming video. If a student wishes to rewatch a video (or chapter from a video), the streaming server must resend the video to the client. Highly compressed video, which uses up far less capacity of a network cable, cannot be effectively streamed in a generic manner for a variety of digital video formats.

A network drive is a hard disk in a computer connected to a network. If a digital video file is stored on a network drive, a video player on another computer on the network can play the file straight from the network drive (in the same manner as the computer would access its own hard drive). During this process, video is still streamed from one computer to another. Network Drive Access, as well as having all the shortcomings of other streaming options, is inadequate because it allows any user of the network to access or copy the digital video file. Further, if a student wishes to rewatch or replay a video (or chapter from a video), the network drive from which the video is being streamed, must re-stream the digital video file to the receiving computer.

It should be considered that the invention is disclosed with reference to the distribution of video files. This is a useful application of the invention, however the reason video files are selected to illustrate the invention is because they are large. The invention is equally useful to the distribution of large music files or multimedia files of various kinds and the invention should not be thought of as pertaining strictly to video.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a representative screen shot of the Player according to the teachings of the present invention;

FIG. 2 is a screenshot of the Player depicted in FIG. 1 showing the searching function;

FIG. 3 is a screenshot from the Player depicted in FIGS. 1 and 2 showing how a Classroom is accessed;

FIG. 4 is a screenshot of a Classroom management window;

FIG. 5 is a screenshot of a window for creating and editing a Classroom;

FIG. 6 is a screenshot of a Library window;

FIG. 7 is a screenshot of the Library window depicted in FIG. 6, showing the features associated with the management of the collection;

FIG. 8 is a screenshot of the Library showing how a Video is added to the history category;

FIG. 9 is a flow chart illustrating the interaction the Player and Library software;

FIG. 10 is a flow chart illustrating Predictive Chapter Buffering; and

FIG. 11 is a chart illustrating Classroom Data Localisation;

FIG. 12 is a screenshot of the TV Player window;

FIG. 13 is a screenshot of the TV Player window depicted in FIG. 12, showing how the menu adjusts as a category is selected;

FIG. 14 is a screenshot of the TV Player window after a video has been selected to play and then having been paused;

FIG. 15 is a screenshot of a page generated by the Library software showing how a video is added using the Video Wizard, including the options of adding a video in the proper format, from a DVD, from a VHS, or in digital format;

FIG. 16 is a screenshot of the Video Wizard generated by the Library software when it gives a user the option of editing the file using the Video Editor, or automatically splitting the file into chapters, or not to split the file;

FIG. 17 is a screenshot of the Video Wizard generated by the Library software when the Video Editor option has been chosen and when a video file has been split into three chapters, and with only chapters 1 and 3 selected to be added into the library; and

FIG. 18 is a screenshot of the Video Wizard generated by the Library software when the option of adding the metadata associated with a video file has been chosen.

### BEST MODE AND OTHER EMBODIMENTS OF THE INVENTION

One of the technologies provided by the present invention is a package of software applications that allows students and teachers to store, view and manipulate digital video files, or any other media files, on a local area network of computers. There are three main parts to this software package. These three parts or software components will be referred to as the Library, the Player, and the TV Player.

The Player and Library have been developed as Windows-based software applications built in Visual Basic using the .NET framework. A Macintosh version of the Player has also been developed using Java 1.4. Other platforms and implementations are possible.

The Library is a software application that enables the storing and serving of digital video files. The Library uses the computer on which it is installed as a server. This means it enables the computer to serve (or transfer) digital video files to any other computer on the local area network which has the Player installed. The Library can be installed and used on any computer on a local area network.

The Player is a software application that enables the viewing of digital video files from any computer on a local area network. The Player is used to search for, browse and request digital video files from the Library. The digital video file remains cached (temporarily stored) on the requesting computer for a specified period of time so that it can be replayed at any time for the convenience of the viewer. The requesting computer can also serve the video to other computers, for example, those in the same classroom.

If the digital video file is chapterised, meaning it is broken up into separate sections of lesser duration, then only those individual chapters need be requested from the Library. Also, chapters from different videos can be requested by the Player at the same time. Further, different videos (or chapters from videos) can be requested and played by several different requesting computers at the same time.

All digital video files stored in the Library are encrypted at all times. When the files are transferred to the Player, they are transferred in encrypted form, and are only unencrypted temporarily by the Player as they are being viewed.

The TV Player uses all the same back-end functionality of The Player. Like the Player, it is a software application that enables the viewing of digital video files from any computer on a local area network, and like the Player it is used to browse and request digital video files from the Library. However, the TV Player is designed with a resolution suitable for televisions, which have a lower screen resolution than computer monitors. To use TV Player with a television, you simply connect the computer on which TV Player is installed to the television. The television then acts as a monitor for the computer. In addition, the TV Player application can be operated using a hand-held remote control. This can be connected via a USB port into the computer.

Two features provide benefits over know distribution solutions. These are predictive chapter buffering and classroom data localisation.

Data Encryption and Compression

In many instances of use, the Library transmits distinct chapters (defined as either arbitrary or purposeful subdivisions of a file) rather than a whole video or a stream of the video to each requesting computer with the Player installed. The Player will not display a chapter until the entire file has been received.

The first benefit is the ability to use more powerful compression technologies to reduce the file sizes of the video files being sent across a local area network, which has the benefit of substantially increasing the number of computers that can receive video files as the files use up less of the bandwidth on the local area network. Compression substantially reduces the load on the processing capacity of the computer on which the Library is installed, which means a substantially greater number of videos can be sent simultaneously. It also provides that video of substantially higher quality (for example DVD quality video) can be sent to, and then viewed on the Player. Additionally, any media format for the video file (MPEG or otherwise) including video files compressed with any codec, can be used and distributed. Distribution of compressed chapters is particularly suited to education and training as visual learning is optimised when it is delivered in smaller, modularised forms (such as chapters). Smaller encrypted video files served to client computers (from the Library to the Player), as smaller files take less time to decrypt than larger files.

Having a smaller file encrypted means the delay between the Player requesting a video to be played and it actually being viewed (after the decryption process) is reduced. If a user wishes to play two chapters of a video consecutively, then reducing the time taken to decrypt a file means a subsequent video file can be sent closer to the time the second chapter needs to be played, meaning a greater number of computers can be sent consecutive chapters. Likewise a complete video can be broken into chapters, and sent only when the computer playing the video requires the chapter (without the viewer realising the video has been broken into chapters), which means the time from the initial request of the video to the playing of the video is reduced, and means a greater number of computers can request video files at the same time.

Within the whole video delivery methodology of the present invention, the video files are encrypted at all times, except for the actual playing of the video by the Player. During the playing of the unencrypted video, the viewer cannot access, copy, delete or corrupt the video file because the Player never leaves an image of the unencrypted file on the user's hard drive. In this manner, the present delivery methodology offers a unique means of ensuring a file cannot be copied, deleted, corrupted or manipulated, except as prescribed by the configuration of the Player.

Maximum Simultaneous Users

When the Library is engaged in serving video files, the central processing unit of the computer on which the Library is installed, is not utilised as the video file is transferred directly from the hard disk to the data buffer on the network interface card. The benefit of this is to remove the limits imposed by the capacity and speed of the central processing unit, which hinders other video delivery techniques. The simultaneous user capacity can be determined using the following equation:

$$Maximum Simultaneous Users = \frac{( Min ( harddisk read bitrate , NIC bitrate ) )}{( video bitrate )}$$

Predictive Chapter Buffering

The present methods are able to effectively deliver highly compressed video to students and teachers (or analogous users) by using Predictive Chapter Buffering. In this way, the Library is able to deliver video of higher quality than other video delivery techniques, with the added flexibility of being able to deliver all digital video formats. The delivery occurs in distinct chapters rather than whole videos, or a stream of the video. The Player does not display a chapter until the entire file has been received allowing for highly compressed videos (which require the entire file to have been received before it can be decoded) to be sent over the network. This technique is not normally associated with video delivery, but is of great use to educational video within a school network since educational video (1) can be easily divided into chapters (2) is often viewed on a per-chapter basis unlike conventional video.

Predictive Chapter Buffering also allows the present system to keep the data encrypted during the transfer of the video between the server and the client.

Using Predictive Chapter Buffering, the invention delivers only the video immediately required by the student, but does not encounter the complexity of video streaming hence allowing for far greater video delivery capabilities.

The sending of chapters from the Library to the Player occurs preferably in a predictive manner. This means the Library and the Player communicate with each other, to determine how long a file will take to send to the Player, and the Library will not send that file until it is needed by the Player.

By using this form of strategy, the present methodology spreads out the processing load on the server and the use of cable bandwidth, which is of benefit because it increases the number of video files that can be requested and viewed simultaneously. It also means whole videos can be played in the one viewing, but broken into chapters without the viewer realising.

The word “buffering” means the temporary storing of data during a computer operation. We use this word in the context of the invention, because a complete chapter file is transmitted to the client computer before playing, unlike streaming where video is pushed across the network in real time.

Predictive Chapter Buffering is achieved by developing the Library so that it individually serves chapter files on demand rather than entire videos. The Library assigns unique identifiers that the Player uses to reference the collection of digital files sitting on the Library. When the Player obtains the details of each video from the Library, it is given a list of the unique chapter identifiers that make up the video.

When a user selects to view an individual chapter, a request for the chapter file with its unique identifier, is sent to the Library. The Library then returns the entire chapter file to the Player. When the Player receives this file, it temporarily stores this video on its local drive, and then displays it to the user.

When a user selects to view an entire video, the Player will request the first chapter of the video from the Library. As the first chapter nears its conclusion, the Player senses that the next chapter will soon be required, and hence will automatically request the entire next chapter from the Library. The Player will compare the amount of time left in the chapter relative to the predicted amount of time required to request/receive the proceeding file from the Library.

Predictive Chapter Buffering has many other benefits: it is unaffected by data traffic spikes on a network due to the chapter-sized video buffer; it lowers the real time urgency of data which needs to be sent to the computer on which the Player is installed; it allows the faster processing of the frame index of an MPEG-4 file by reducing the seek latency since the entire file exists locally at the point of display; and it allows the caching of video which has the consequential benefit of enabling remote usage.

Classroom Data Localisation

One of the functions available in the Player is the ability to set up a Classroom Folder and deliver to it one or more videos, or chapters from videos. A Classroom Folder is a folder set up by the Player which thereafter acts as a server and can be seen and accessed on other computers on the network. It is done by simply clicking and dragging the icons for the videos or chapters of videos into the Classroom Folder.

When the whole video or chapter files are first selected, they appear in the Classroom Folder as ‘ghost images’ of the files. When the Classroom Folder is confirmed to be added, the files are then sent to the requesting or client computer. The requesting computer is then initialised to become a server itself, able to serve video files to other computers located in the same physical room or in close proximity of its connection to the network. This is deemed Classroom Data Localisation.

Classroom Data Localisation has several key benefits. It reduces the load on the main server on the local area network, as another computer (or computers) on the network are being used as a sub-server. It is able to reduce the latency between the request of a video file by the Player and the receiving of the file as the sub-server is physically closer to the client computers on the network. It substantially increases the potential number of concurrent viewers of a video file, as any number of sub-servers can be established. For example, if the server capacity, and bandwidth capacity mean 20 terminals could be sent a video file at the same time, then by sending the file to 20 sub-servers, means the total number of viewers can be increased to 400, as 20 sub-servers could then send on to 20 terminals each in their vicinity. In combination with the predictive sending of smaller chapters of files, this greatly increases the number of viewers and the number of video files that can be viewed at any one time.

Classroom Folders may be created with a mixture of media files (videos, chapters from videos, still photographs, Word documents, Flash files, or anything that can be stored as a digital file). Moreover, each terminal on which the Player is operating to control the playing of the video (stopping, replaying etc), is also able to simultaneously run other media and other functions on that computer (such as having a web browser open, or a word document, or otherwise).

In a learning or training environment, this facilitates self-paced learning, as well as the use of multi-media by teachers and students, without special training or technical know-how. As hardware and network capacity increases, the capacity to view videos (or any other media file) using the invention will not increase incrementally (as it would with streaming), it will increase exponentially.

Classroom Data Localisation is achieved by porting the file serving capabilities of the Library into the Player. In this way, when a teacher creates a lesson plan for the class, the teacher's computer automatically becomes a localised server for the students located within that area of the network.

When the user of the Player creates a Classroom Folder, the selected files will be sent from the Library to the Player and then temporarily stored on their local drive. The Library then obtains the IP address of the ‘sub-server’ machine which these files are now also stored on. A socket on the Player is then opened which listens for requests for these files from another instance of the Player. When another user of the Player tries to access the contents of this Classroom Folder, the Library will be instructed to forward the request to the IP address associated with the sub-server (as depicted by the details of the classroom). If the sub-server is unable to process the request, the request will be forwarded to the Library.

Illustrative Examples of the Invention

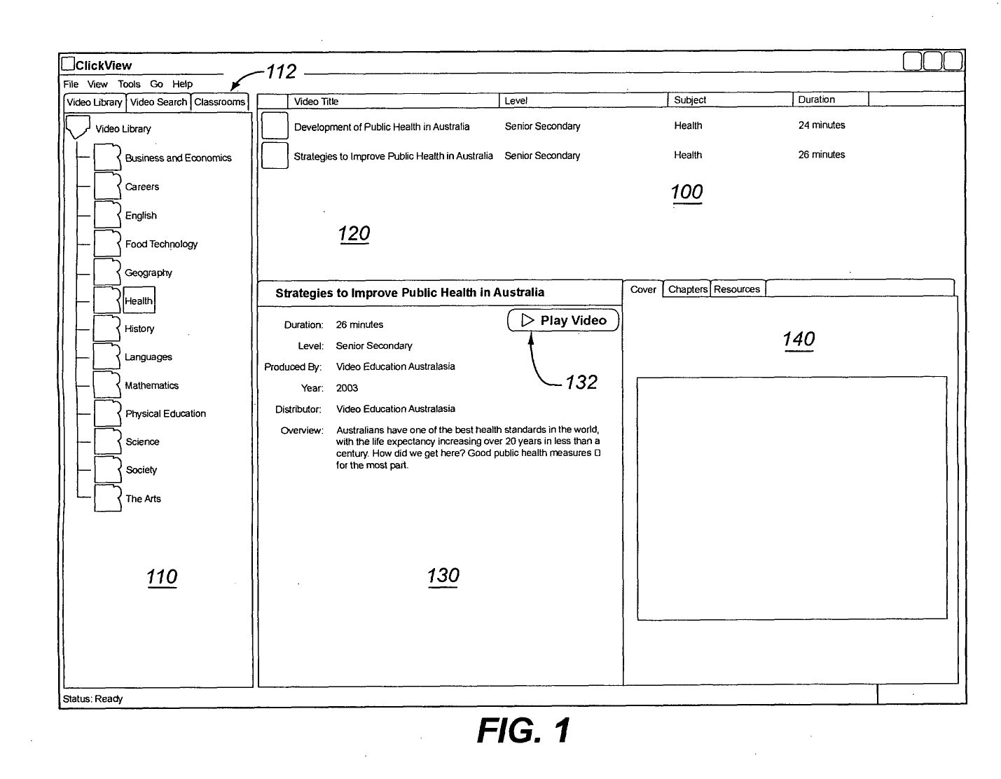

As shown in FIG. 1, the Player software is accessed by a graphical user interface (GUI) 100 depicted on a user's PC as window 1 which is subdivided into several functional areas. A subdivision or a frame of the window 110 along the left margin includes a viewing area having 3 tabs 112. The tabs are ‘Video Library’, ‘Video Search’, and ‘Classrooms’. As shown in the frame 110, the Video Library view comprises a root directory entitled ‘Video Library’ which has various branches representing topics, for example, ‘Business and Economics’, ‘Careers’ and ‘English’. Each of these topics is represented by an icon and can be expanded or contracted with conventional mouse functionality. A view area or frame 120, located for example along the upper margin of the main window 100 shows the contents of the selected branch of the root directory and some basic information such as level, subject and duration. In this example, the directory ‘Health’ is shown as having 2 videos as its contents. One is entitled ‘Development of Public Health in Australia’ and the other is entitled ‘Strategies to Improve Public Health in Australia’. Accordingly, selected metadata about the selected video is depicted in the third frame or view area 130. As shown in this example, the viewing area 130 depicts useful synopsis information about each video such as duration, educational level, the identity of the producer, the year, the distributor and the brief overview. The area 130 also includes a play button 132. A fourth viewing area 140 is tabbed to allow the user to access the Video artwork or cover, a list of chapters and other miscellaneous resources that are linked or relevant to the particular video being selected.

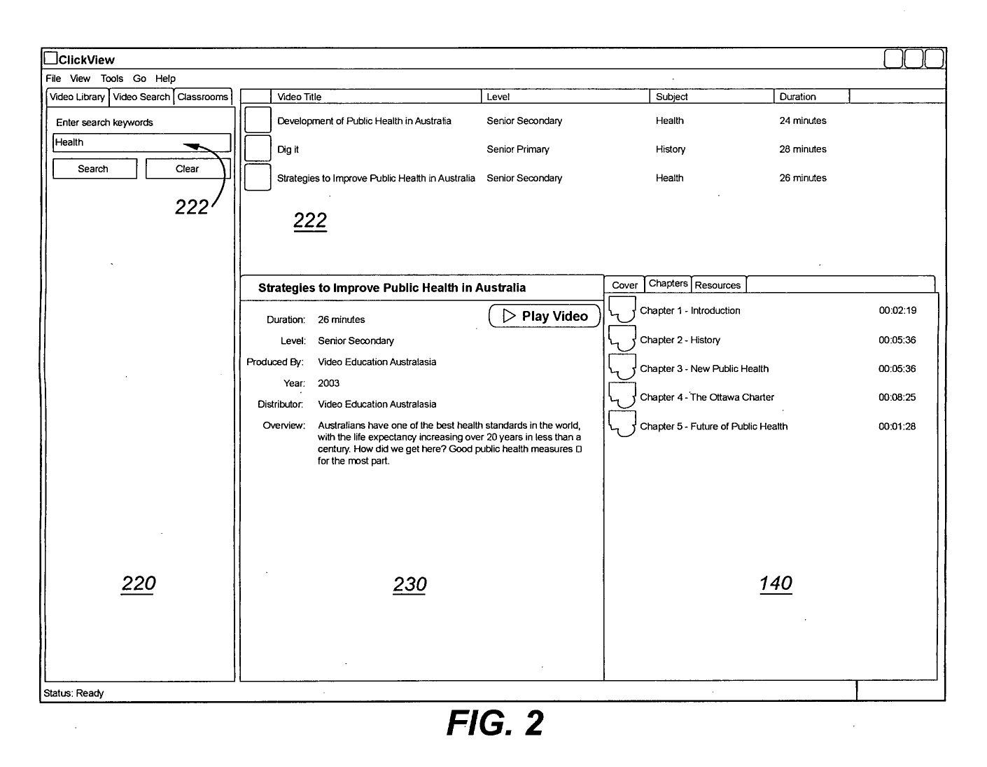

As shown in FIG. 2, the same Player GUI window may allow a user to search the remote Video Library by selecting the ‘Video Search’ tab to display a search area 220. The sub-window or frame includes a query field 222 that allows a user to input a keyword or string and perform a search. The results of the search are depicted in a separate frame 222. The selection of a title in the display frame 222 causes the depiction of metadata in a third window 230. In this view it can also be seen that when the ‘Chapters’ tab is selected in the fourth sub-window or frame 140, a selectable list of chapters and their titles are displayed. Information about each chapter including duration may also be depicted. Double click on a chapter icon in frame 140 to view just that chapter.

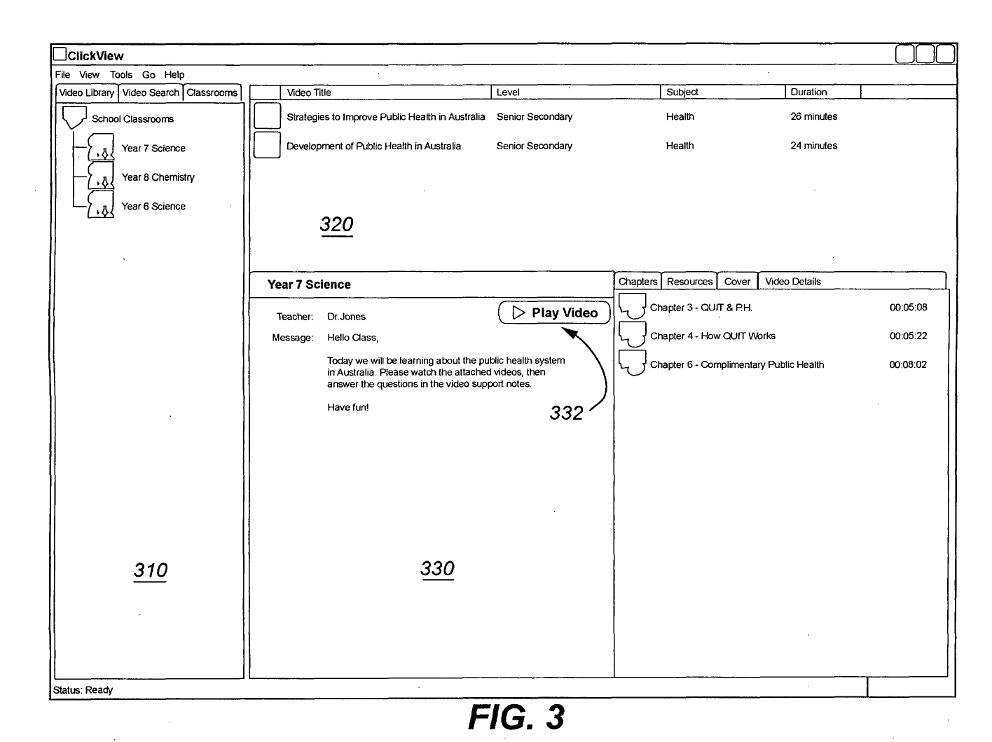

As shown in FIG. 3, the Player window, can also display a list of Classrooms when the Classroom tab is selected in the left hand frame. As shown in this example, the Classroom frame 310 depicts a directory structure in which branches of the directory represent different Classrooms that have server capability. The selection of a Classroom depicts in a separate area 320 the accessible contents of that Classroom. When a user selects a particular video from the second area 320 information is displayed in a third area 330 that relates to the selected video from the second window 320. Information is displayed in the third window 330 that relates to the selected video. Note that the third window 330 can contain the identity of a teacher as well as a Classroom message from that teacher. The video play button 332 may also be conveniently located in the same window.

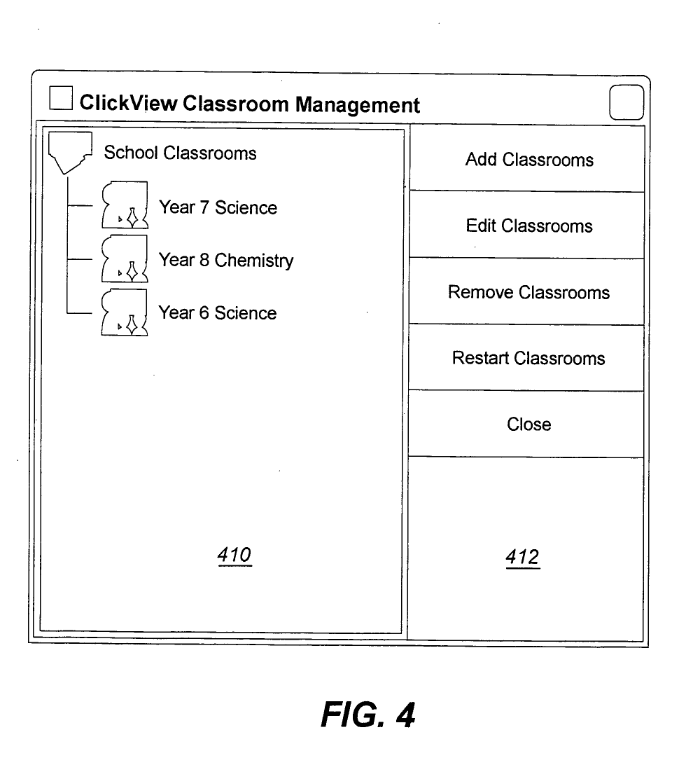

FIG. 4 depicts a window that is used by personnel authorised to manage and edit Classrooms. In the left hand view area 410, a directory tree of Classrooms is presented. Buttons along the right hand side 412 allow a user to add a Classroom, edit a Classroom, remove a Classroom, restart a Classroom or close the window.

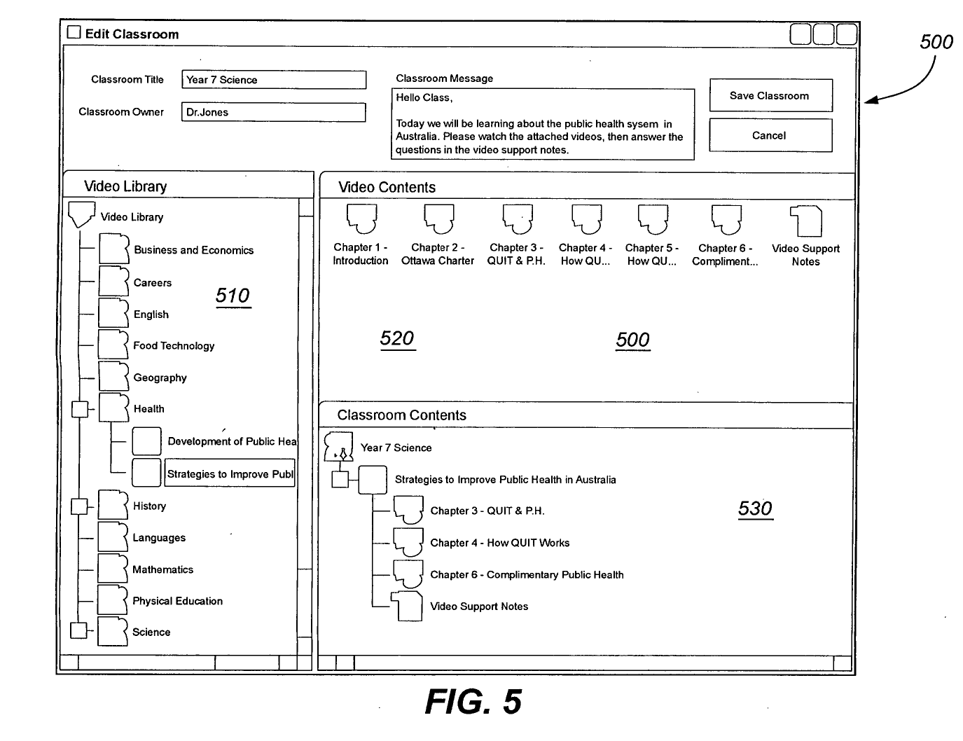

Selecting the ‘Edit Classroom’ button of the Classroom management tool depicted in FIG. 4 opens an interface 500 of the type depicted in FIG. 5. Depicted in this window are the fields that allow a Classroom to be created such as the Classroom Title, Classroom Owner and Classroom Message. Also depicted are a directory browsing area 510 that displays the contents of the Video Library and a contents viewing area 520 that shows the contents of any topic in the Library that is selected. In this example, the ‘Health’ directory of the Video Library has been selected to display its contents. One of the categories under the directory ‘Health’ is the sub-directory ‘Strategies to Improve Public Health’. Because it is selected, its contents are displayed in the area 520. One can see chapters 1-6 as well as a relevant video support note in .pdf format. Using the Video Library sub-window 510 and the Video contents area 520, chapters and other immediate resources can be dragged into the Classroom Contents area 530 to create content for particular selected Classroom in this case, Year 7 Science.

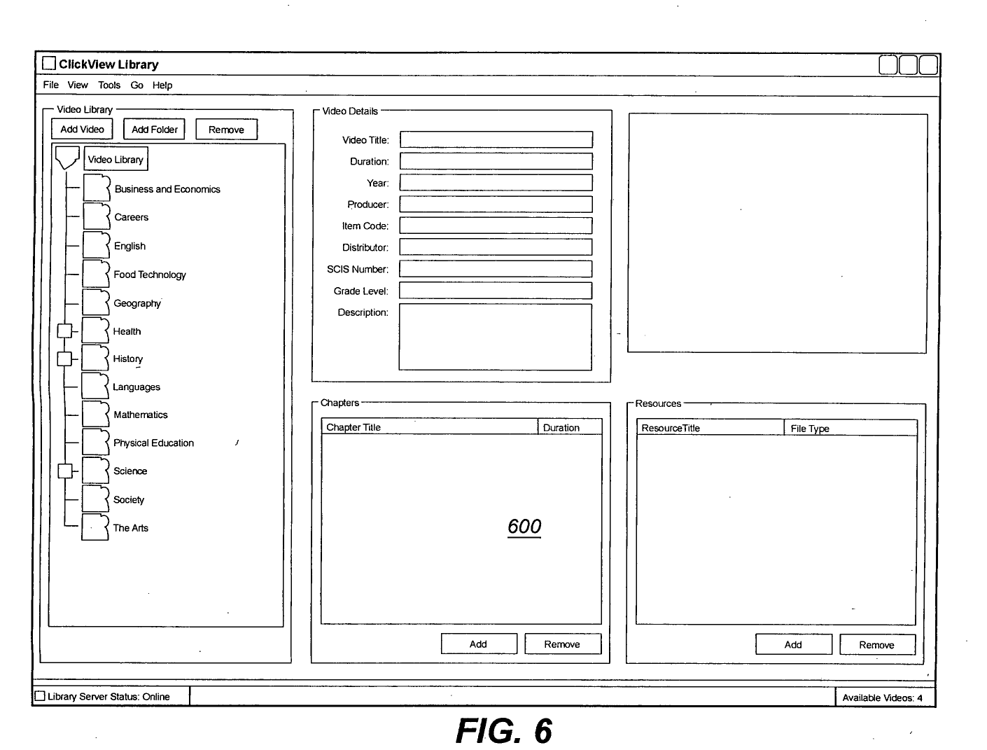

As shown in FIG. 6, the graphical user interface to the Video Library is depicted as a window 600. As seen in the lower left hand corner, the Library server status in indicated as ‘Online’.

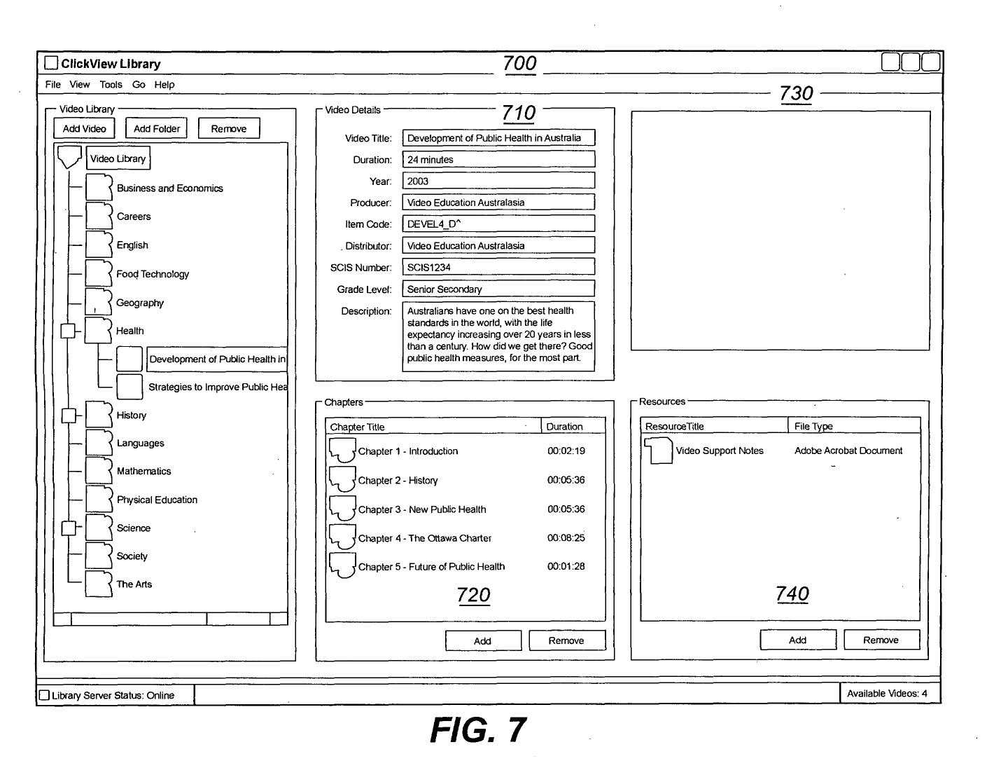

As shown in FIG. 7, a collection can be managed because the contents of the Video Library can be viewed, added to or removed from. Metadata about a particular selected Video are displayed in a viewing area 710 and icons and chapter titles including, for example, their durations are shown in a separate area 720. The main window 700 may include a video viewer or multimedia player 730 which can be used to preview videos or other media. A separate window 740 depicts resources that are associated with a particular video.

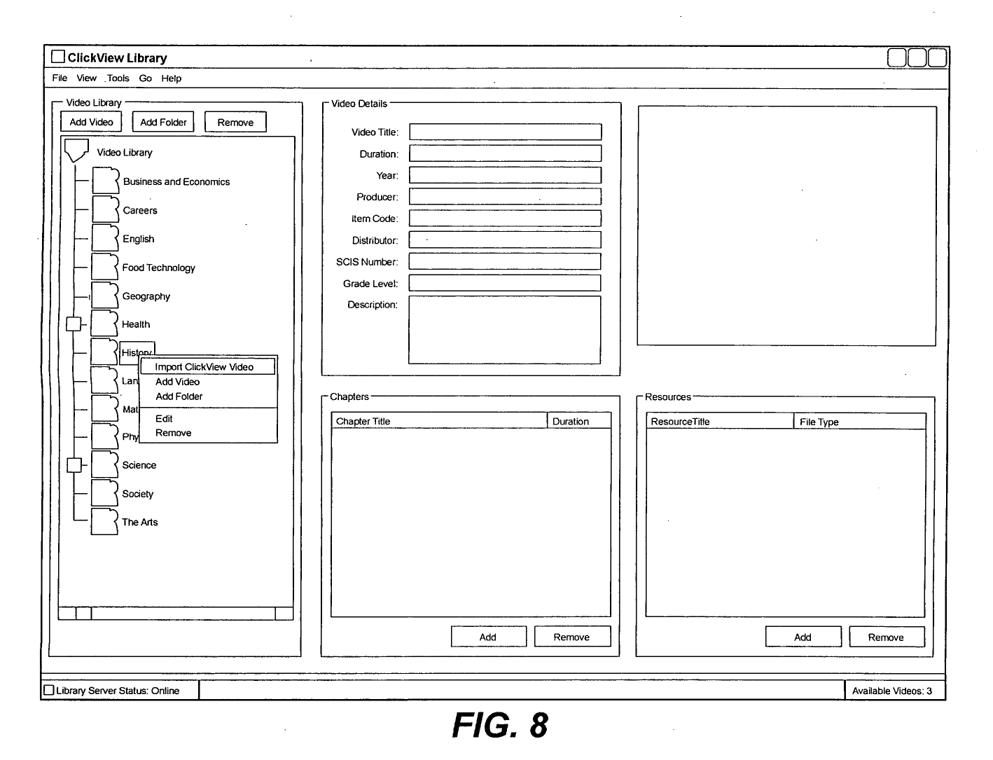

As shown in FIG. 8, adding a video to the Library can be done using mouse button functionality. In this example, the selected category ‘History’ is associated with a pop-up menu that allows a user to import a Video, add a Video, add a folder or edit or remove that category.

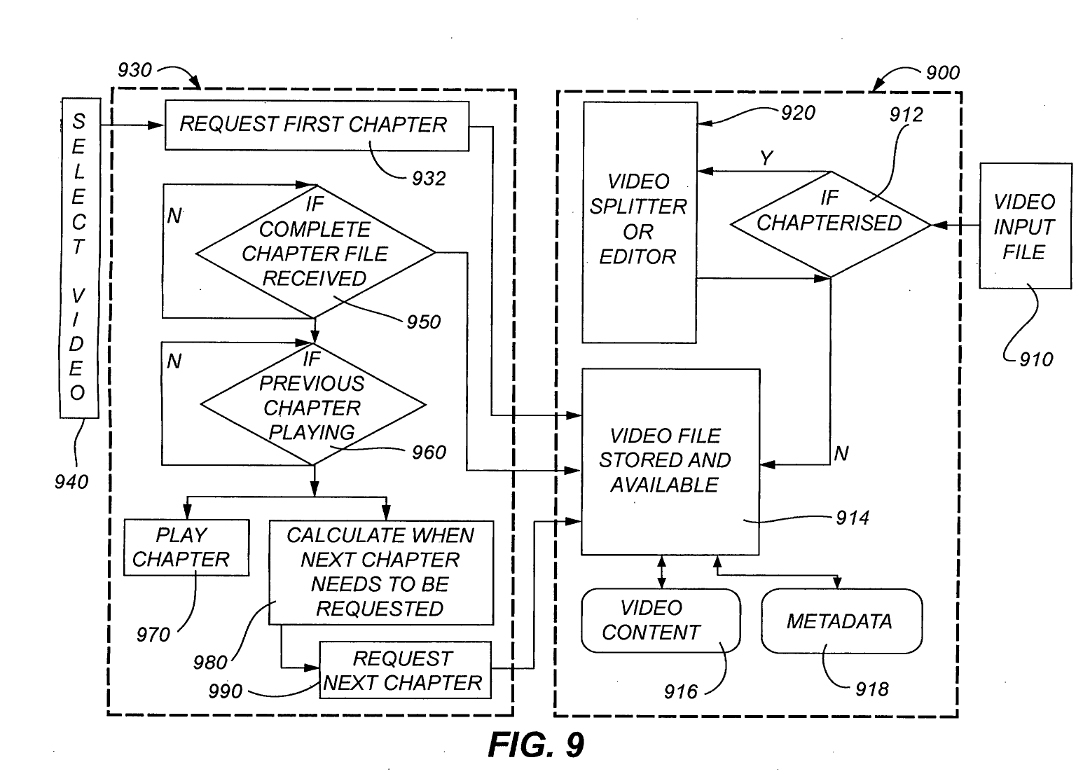

As shown in FIG. 9 the Library software 900 receives a Video file 910 as an input. If the video file is smaller that about 30 MB then it is left intact. If it is larger than about 30 MB it is partitioned in 2 or more segments or chapters. In most embodiments, segment or chapter sizes of about 20 MB are preferred. A large video can be chapterised by detecting key frames and sub-dividing the larger file into appropriate segments that are defined by selected and convenient key frames. Some inputs 910 are handled as modules, that is, segments that are accompanied by separate and descriptive metadata. The software detects 912 if an input Video file has been chapterised. If it has been chapterised the file is stored to a hard drive and made available 914. In preferred embodiments, the video content 916 and the metadata files 918 are stored separately. If the input file is not chapterised the file is operated on by a splitter program 920 which breaks the input video down into conveniently sized chapters which are then stored and made available 914 as previously discussed.

As also suggested by FIG. 9 and in some alternate embodiments, the Library software 900 receives a Video file 910 as an input that may be chapterised. If so, a Video Editor can be used in an automated manner which makes smaller files of approximately 30 MB, or manually where it can be made into files of any size. For the optimal performance of the invention, chapter files should be less than 50 MB. A video file can be chapterised by detecting key frames and sub-dividing the file into appropriate segments that are defined by selected and convenient key frames. Some inputs 910 are handled as modules, that is, segments that are accompanied by separate and descriptive metadata. The modules are stored on a hard drive and made available 914. In preferred embodiments, the video content 916 and the metadata files 918 are stored separately.

As further shown in FIG. 9 the Player software 930 allows the user 940 to make a request 932 by means of a graphical user interface. The request is transmitted over a TCP/IP network to the Library program 900. The first of the selected chapters is transmitted to the requesting Player 930. The incoming file is checked for completeness 950. If the complete chapter is received, the software determines if a previous chapter is playing 960. If not, the chapter is played 970 and a determination calculation is performed which predicts when the next chapter has to be requested 980 (see below). At the appropriate time, and before the completion of the previous chapter, the next chapter is requested 990 in time for timely uninterrupted viewing on the Player 930.

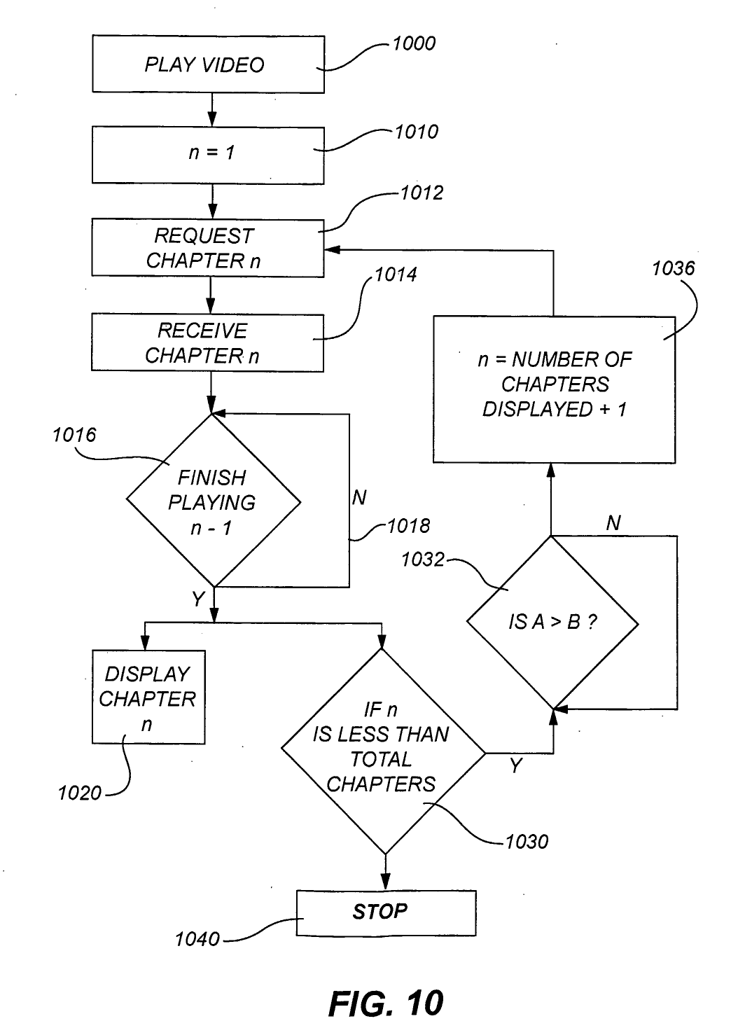

FIG. 10 illustrates a schematic diagram that illustrates aspects of Predictive Chapter Buffering. As the Player software application plays a video 1000 a chapter counter 1010 designated n is set to n=1. The designation “n” corresponds, for example, to a chapter position on a user's playlist rather than an actual chapter number, although these might be the same in some instances. After this, a request 1012 is made for chapter n. As a result, chapter n is received 1014. The software then determines whether a previous chapter designated n−1 has finished playing 1016. This process continues 1018 until the condition is met that there is no chapter n−1 playing. At that point, the display of chapter n begins 1020. If n is less than the total number of chapters requested then a determination is made 1032. The determination results in a next chapter request 1012, after an increment 1036, if the timing is appropriate. The timing is appropriate if it is determined that A>B 1032. In this example of a request timing determination, A is equal to the time remaining in the display of chapter n, and B is (I×Sn+1×SF)/Sn, where I is the time interval measured between the time that chapter n was requested and the time it was received, Sn+1 is the file size of n+1, SF is a safety factor (e.g. 2 in this example) and Sn is the file size of n. At the appropriate time indicated by the determination, the next chapter, still designated as chapter n but incremented to the next chapter 1036, is requested 1012. If after the display of chapter n 1020, it is found that n is equal to the total number of chapters 1030 the software causes the Player to stop displaying chapters 1040.

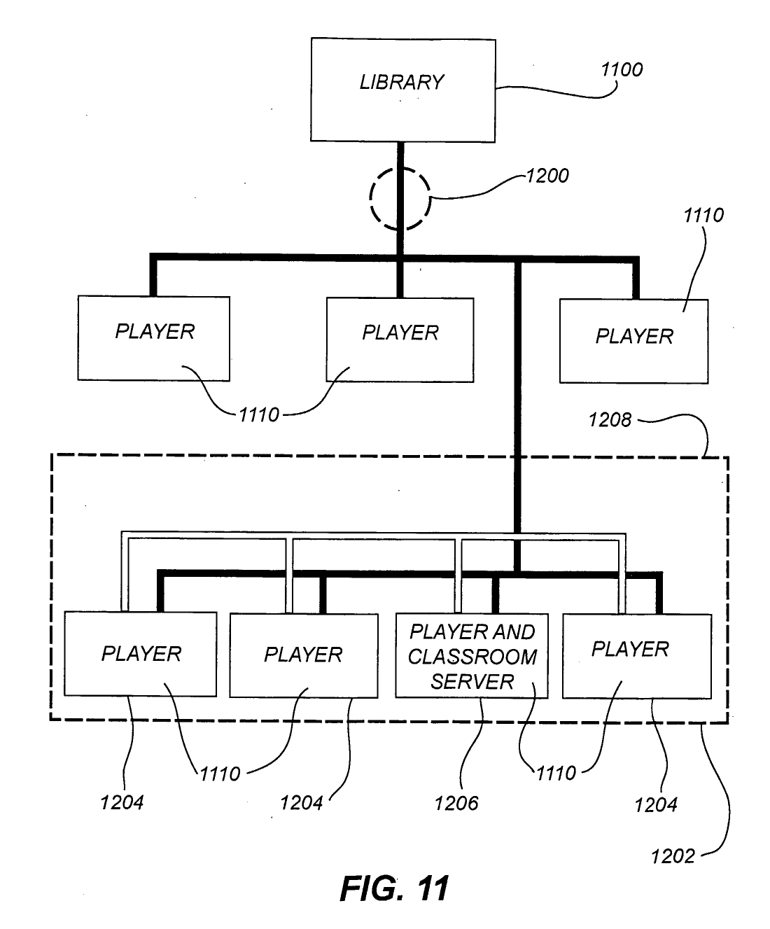

As shown in FIG. 11 a Library, as previously described 1100, is able to serve a number of Players 1110. Network congestion in the most critical location 1200 may be at least partially alleviated by configuring a Player on one particular computer 1206, to act as a sub-server to other computers anywhere on the network, but optimally to computers physically near it on the network such as those in the physical room represented at 1208. A sub-server, being physically closer to other computers on a network means transfer latency can be minimised. This particular Player software is able to serve a requested video to nearby computers that are running the Player software 1204. In this way, the computers 1204 which receive content from the Classroom server 1206 need not place any demand on the Library 1100 or congested portions on the network 1200.

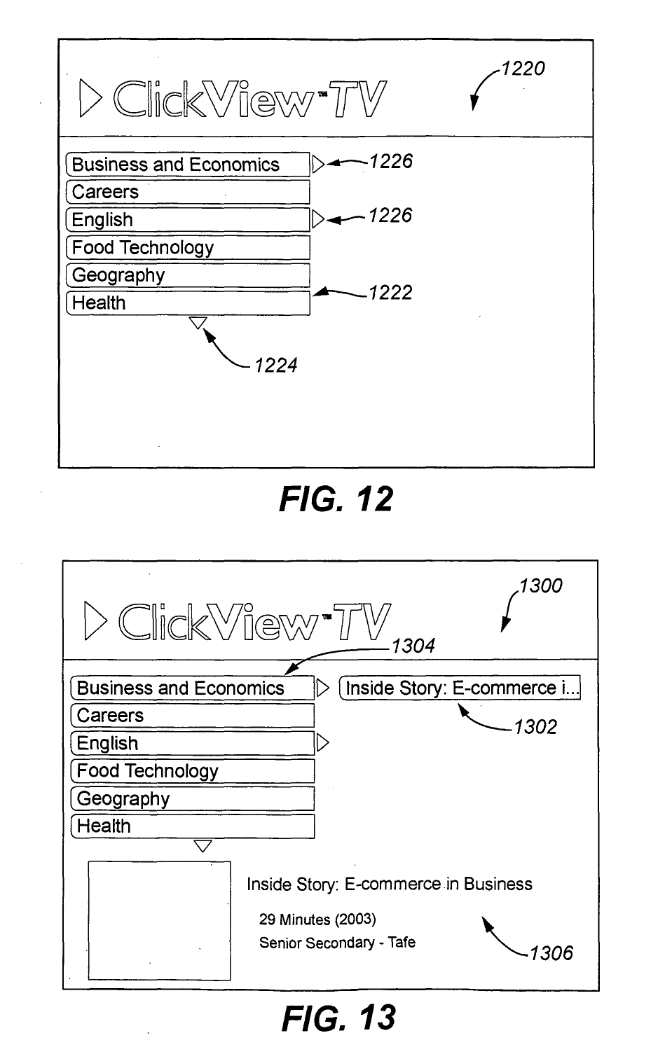

FIG. 12 illustrates one embodiment of the TV Player window 1220. It comprises a menu of topics 1222 with indicators that the menu is longer than shown 1224, and that there is additional information for some topics 1226. FIG. 13 illustrates the TV Player window 1300 depicted in FIG. 12, showing how the menu is adjusted as a category is selected. The sub-topic item 1302 is shown when the topic 1304 is selected. The lower portion of the screen 1306 changes to show additional information regarding the sub-topic selected.

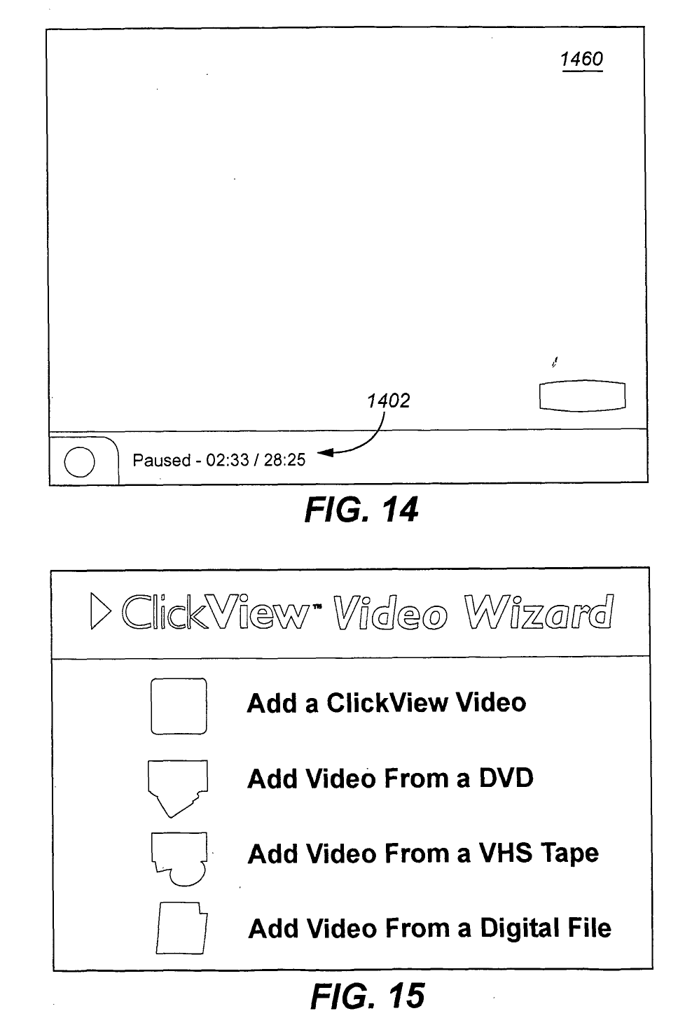

FIG. 14 illustrates the TV Player window 1400 after a video has been selected to play and then having been paused. Additional information about the status of the video being played is shown in the message area at the bottom of the window 1402.

Adding Video files to the Library

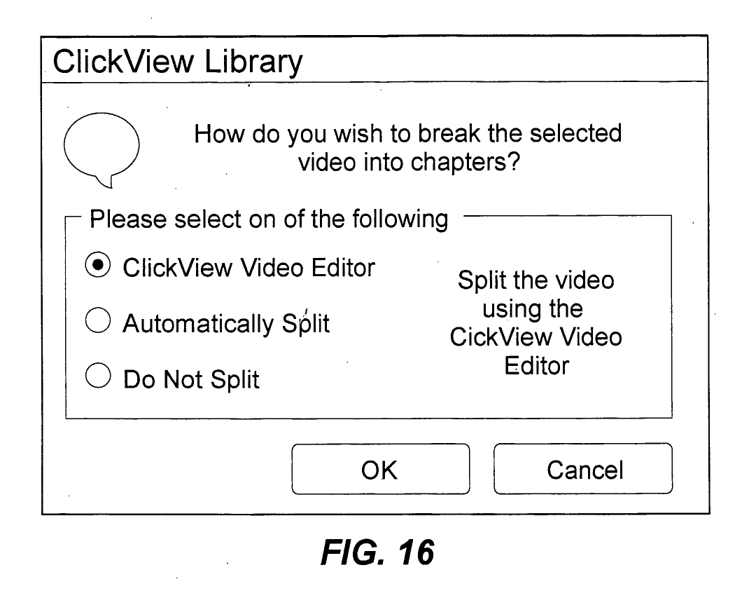

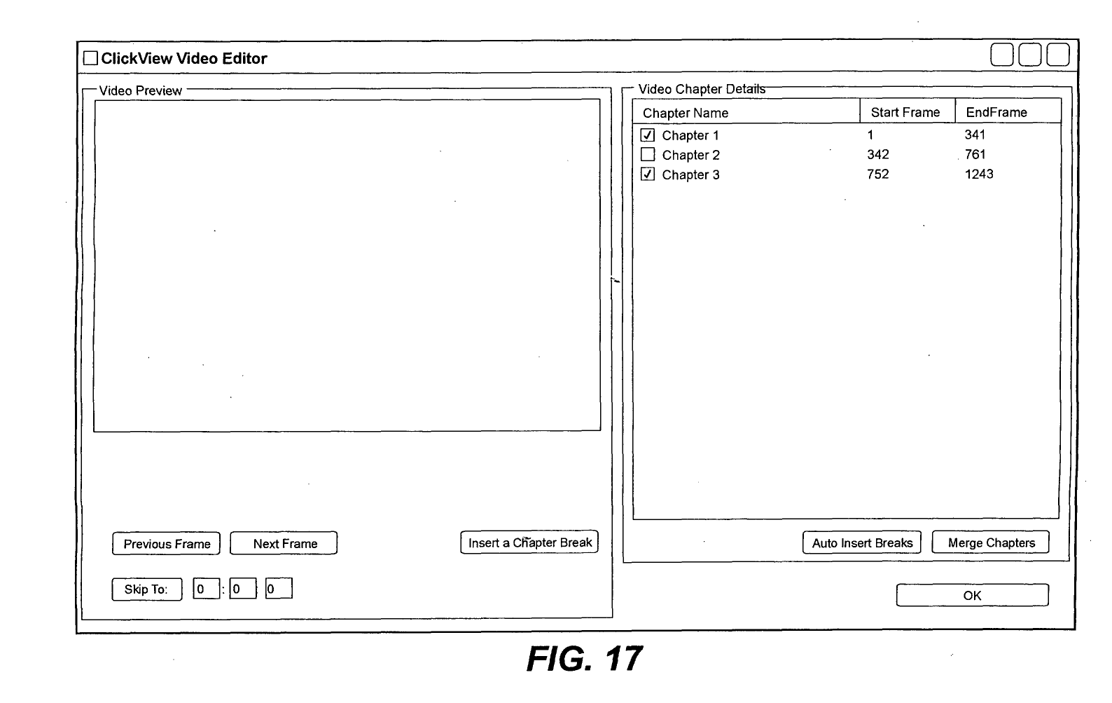

As suggested by FIGS. 15-18, the Library software has a means of adding video files from different sources and in different formats: in digital format, from VHS and from DVD. This component of the Library is referred to as the “Video Wizard” (see FIG. 15). The “Video Wizard” displays, by serving pages to its users, options and menus for incorporating andm managing video content in a variety of formats. If the file is already in digital format, including as an MPEG2 on a DVD, the Video Wizard will reduce the file in size by converting it to MPEG4 using an in-built converting codec. The Video Wizard then provides the option of adding the video file to the Library as an unedited and unchapterised MPEG4, or to automatically chapterise it into file sizes of approximately 30 MB, or to use the Video Editor to manually edit and chapterise the video file (see FIG. 16). It also provides the option of adding only selected chapters of the original video file, which is an efficient means of editing out or removing unwanted parts of the video file (see FIG. 17).

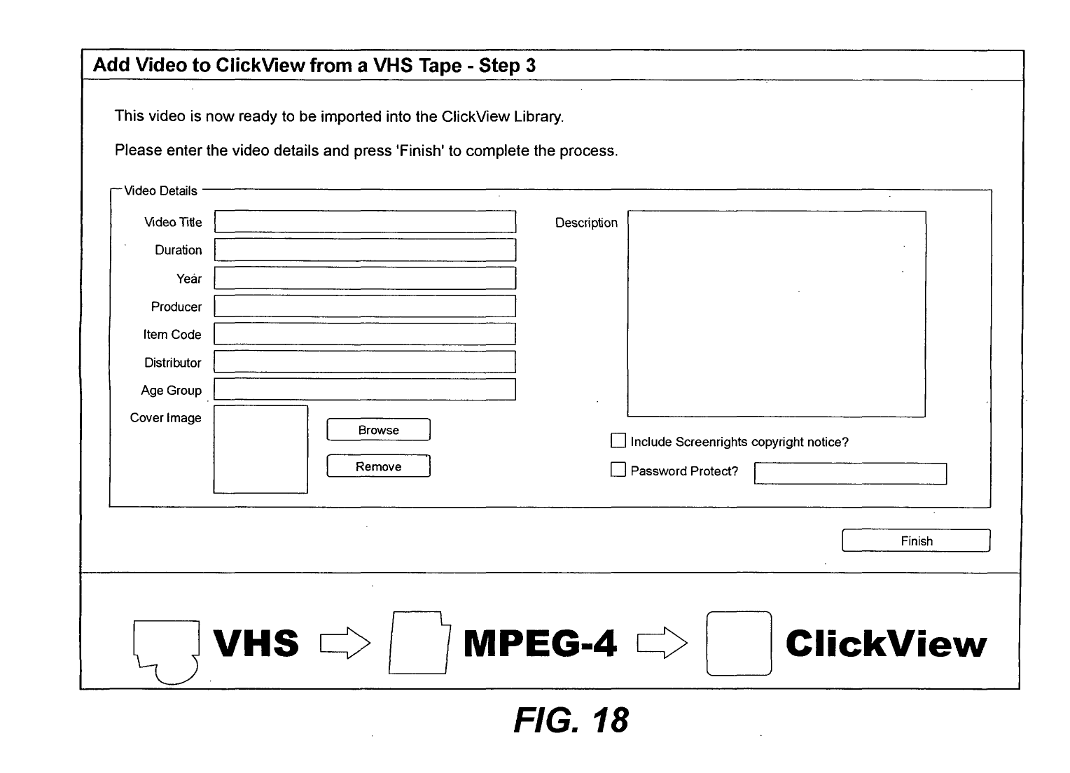

If the video file is a VHS, the Video Wizard requires and works interroperably with a hardware device to convert from analogue videotape into a digital video file (see FIG. 18). Once the video is in digital format, it can be added to the Library. Since the Video Editor can chapterise and edit already compressed video (MPEG4), when the VHS is converted to digital format, it can simultaneously be compressed to MPEG4, which offers significant time savings since it takes real time to convert from analogue to digital format, and real-time to compress a digital file from the raw digital video to MPEG4. If these functions are done simultaneously, it halves the time taken to add a video file to the Library.

In addition, the Video Wizard function, with its in-built codec to convert digital video files to MPEG4, works interoperability with hardware devices called TV tuner cards. TV tuner cards allow programs broadcast on television or transmitted by fixed cable to be captured into digital format. The Video Wizard function, working interroperably with a TV tuner card, can compress the digital video into MPEG4 at the same time as it is being captured by the TV Tuner Card. This has the significant benefit of allowing the Video Wizard to schedule and automatically add programs into the Library from broadcast television.

Once a video file is added to the Library, it can be immediately accessed and used by the Player and the TV Player.

We claim:

1. A computer-readable medium comprising computer-executable instructions for the storage and distribution of media files, the software comprising:
a library program managing a plurality of encrypted media files, and
a player program for displaying media files on an audio-visual device, the player program in network communication with the library program, wherein:
the player program requests a media file from the library program,
the library program sends the media file to the player program in an encrypted format,
when the media file is completely received, the player program decodes the file into an unencrypted format and displays the media on an audio-visual device.

2. The software of claim 1, wherein:
the library program operates on a first computer system and the player program operates on a second computer system connected to the first computer system on a network.

3. The software of claim 1, wherein:
the player program decodes the file into an unencrypted format without writing the unencrypted format to a file and without allowing the operator of the second computer to access, copy, delete, or corrupt the unencrypted format while the unencrypted format is being displayed or at any time thereafter.

4. The software of claim 1, wherein:
a first player program automatically creates a public folder containing a data file, the folder being stored on the second computer such that a second player program operating on a third computer in the network requests and receives the data file from the first player program.

5. The software of claim 4, wherein:
the data file is an encrypted media file requested and received from the library program.

6. The software of claim 5, wherein:
a network address of the first player program is retained by the library program after a transfer of an encrypted media file to the first player program, and subsequent requests of the library program for the same encrypted media file are transferred to the first player program by the library program using the network address.

7. The software of claim 1, wherein:
an application program operates simultaneously with the player program on the second computers, the application program operating on digital files available to the second computer.

8. The software of claim 1, wherein:
the player program requests a second media file from the library program at a predicted time during the display of a first media file such that the second media file completely received before the end of the display of the first media file.

9. The software of claim 8, wherein:
a sequence of media files are requested of the library program by the player program and are displayed in order on the audio-visual device, where each subsequent media file is requested and complete received by the player before the display of the previous media file is complete.

10. The software of claim 1, wherein:
the audio-visual device is a television.

11. A method of distributing media in a network, the method comprising the steps of:
storing an encrypted media file on a library managed by a library program operating on a first computer in the network,
requesting the encrypted media from the library program by a player program operating on a second computer in the network,
receiving the encrypted media file completely at the second computer,
dynamically decoding the encrypted media into an unencrypted format,
displaying the unencrypted format on an audio-visual device.

12. The method of claim 11, wherein:
a second media file is requested by the player program from the library program at a predicted time while the unencrypted format is being displayed,
wherein the second media file is completely received by the player program at a time earlier than a time the unencrypted format display is complete.

13. The method of claim 11, wherein:
the audio-visual device is a television.

14. The method of claim 11, wherein:
the unencrypted format is simultaneously displayed on a second audio-visual device.

15. The method of claim 11, wherein:
a second player program operating on a third computer in the network,
requests the media file from a second library program operating on the second computer in the network.

16. The method of claim 11, wherein:
the unencrypted format is displayed without writing to a storage device.

17. A method for transferring a first media file having a first size and a second media file having a second size from a library program operating on a first computer in a network to a player program operating on a second computer in the network, the method having the steps of:
a) the player program requesting the first media file from the library program at a first time,
b) the player program receiving the complete first media file at a second time,
d) the player program displaying the first media file on an audio-visual device, wherein the displaying of the first media file will complete at a third time,
e) the player program requesting the second media file at a predicted time,
f) the player program receiving the complete second media file at a fourth time, wherein the fourth time is earlier than the third time,
g) the player program displaying the second media file on the audio-visual device.

18. A method for transferring a first media file having a first size and a second media file having a second size from a library program operating on a first computer in a network to a player program operating on a second computer in the network, the method having the steps of:
a) the player program requesting the first media file from the library program at a first time,
b) the player program receiving the complete first media file at a second time,
d) the player program displaying the first media file on an audio-visual device, wherein the displaying of the first media file will complete at a third time,
e) the player program requesting the second media file at a predicted time,
f) the player program receiving the complete second media file at a fourth time, wherein the fourth time is earlier than the third time,
g) the player program displaying the second media file on the audio-visual device.

19. The method of claim 18, wherein:
the predicted time is calculated using the steps:
a) a first interval is calculated as the difference between the second time and the first time,
b) a transfer rate is calculated by dividing the first size by the first interval,
c) a second interval is calculated by multiplying the transfer rate by the second size,
d) a third interval is calculated by multiplying the second interval by a safety factor,
e) the predicted time is calculated by subtracting the third interval from the third time.

20. The method of claim 19, wherein:
the safety factor has a value of about 2.
